(19) United States
(12) Patent Application Publication
(10) Pub. No.: US 2020/0262098 A1
(43) Pub. Date: Aug. 20, 2020

(54) HAND-OPERATED PLANER PROVIDED WITH BOTH A FIXED WORKBENCH AND A LIFTING MECHANISM WITH A LOCKING FUNCTION

(71) Applicant: Bor-Yann CHUANG, Taichung (TW)

(72) Inventor: Bor-Yann CHUANG, Taichung (TW)

(21) Appl. No.: 16/276,150

(22) Filed: Feb. 14, 2019

(51) Int. Cl. B27C 1/14; B25H 1/16

(52) U.S. Cl. CPC B27C 1/14; B25H 1/16

(57) ABSTRACT

A hand-operated planer provided with both a fixed workbench and a lifting mechanism with a locking function is combined with a hand-operated planer, which includes a base, a movable workbench, a fixed workbench and a lifting mechanism. The lifting mechanism is composed of a connecting seat, a position-limiting member, an operating rod and a positioning block. When the handle of the operating rod is moved, the operating rod will actuate the position-limiting block of the position-limiting member to operate and drive the driven plate of the connecting seat to rotate via transmission of the connecting rod and thus, the movable workbench assembled above the axis of the connecting seat can be adjusted in height.

### BACKGROUND OF THE INVENTION

### 1. Field of the Invention

This invention relates to a lifting mechanism, particularly to a hand-operated planer provided with both a fixed workbench and a lifting mechanism with a locking function.

### 2. Description of the Prior Art

Generally, a conventional planer is provided with a lifting mechanism for heightening or lowering the workbench of the planer in order to adjust high and low cutting position of a work piece. The lifting mechanism contains a driving shaft, a driven shaft, a rotating seat and a connecting rod seat. When the lifting mechanism actuates the operating portion of the driving shaft to rotate, the driving shaft will actuate the first driven wheel of the driven shaft to rotate and. simultaneously, the third driven wheel of the rotating seat will be rotated through the transmission of the second driven wheel. At this time, the rotating seat will carry out relative rotation and actuate the connecting rod seat to operate and further enable the moveable workbench assembled on the connecting rod seat to be adjusted in height.

However, the conventional planer is to have the operating portion of the lifting mechanism rotated for the rotating seat to carry out relative rotation and actuate the connecting rod seat to operate to enable the movable workbench on the connecting rod seat to be fine adjusted to a height desired and then uses a locking button to tighten the rotating wheel of the operating portion, letting the rotating wheel impossible to be operated and thus attaining lifting and locking effect. But such an adjustment mode needs to have the operating portion and the locking button carrying out two-stage adjustment, thus taking a long time, necessary to be operated and controlled with two hands, consuming time and causing inconvenience in use. Therefore, having observed foresaid drawbacks, the inventor of this invention thinks that the lifting mechanism of the workbench of the conventional hand-operated planer needs to be ameliorated and thereupon advises this invention.

### SUMMARY OF THE INVENTION

The objective of this invention is to offer a hand-operated planer provided with both a fixed workbench and a lifting mechanism with a locking function. The lifting mechanism is simple in structure and able to adjust the movable workbench of the planer to a predetermined height with one-stage adjustment and one hand operation, convenient in use.

The hand-operated planer provided with both a fixed workbench and a lifting mechanism with a locking function in the present invention is combined with a hand-operated planer. The hand-operated planer includes a base provided with a cutting member and the base has two sides respectively provided with a fixed workbench and a movable workbench. The lifting mechanism contains a connecting seat, which is rotatably connected with the base and the movable workbench, and the connecting seat is connected with a position-limiting member, which contains a position-limiting groove and is inserted with an operating rod having a free end fixed with a positioning block corresponding to the position-limiting groove and thus, the operating rod can actuate the positioning block to be fixed or to be released in the position-limiting groove. When the positioning block is released in the position-limiting, groove, the operating rod can actuate the position-limiting member together with the connecting seat to act and adjust the height of the movable workbench, and when the positioning block is engaged and fixed in the position-limiting groove, the operating rod will be tightly locked in the position-limiting groove.

The hand-operated planer provided with both a fixed workbench and a lifting mechanism with a locking function of this invention can adjust the lifting position of the movable workbench with one-stage adjustment and further can stably fixed the movable workbench with the base by means of the positioning block to fix and stabilize the lifting mechanism, convenient in use. Moreover, when the hand-operated planer is to be adjusted, the lifting mechanism can quickly and precisely carry out adjustment to a predetermined height.

### BRIEF DESCRIPTION OF DRAWINGS

This invention will be better understood by referring to the accompanying drawings, wherein:

FIG. 1 is a perspective view of a hand-operated planer provided with both a fixed workbench and a lifting mechanism with a locking function in the present invention;

FIG. 2 is a detailed perspective view of a hand-operated planer provided with both a fixed workbench and a lifting mechanism with a locking function in the present invention;

FIG. 3 is a partial exploded perspective view of the hand-operated planer provided with both a fixed workbench and a lifting mechanism with a locking function in the present invention, showing a state of the exploded lifting mechanism;

FIG. 4 is a partial exploded perspective view of the hand-operated planer provided with both a fixed workbench and a lifting mechanism with a locking function in the present invention;

FIG. 5 is a schematic view showing a locked state of the lifting mechanism in the present invention;

FIG. 6 is a schematic view showing a released state of the lifting mechanism in the present invention; and

FIG. 7 is a schematic view of the hand-operated planer provided with both a fixed workbench and a lifting mechanism with a locking function in the present invention, showing a state that the movable workbench is adjusted in height.

### DETAILED DESCRIPTION OF THE PREFERRED EMBODIMENT

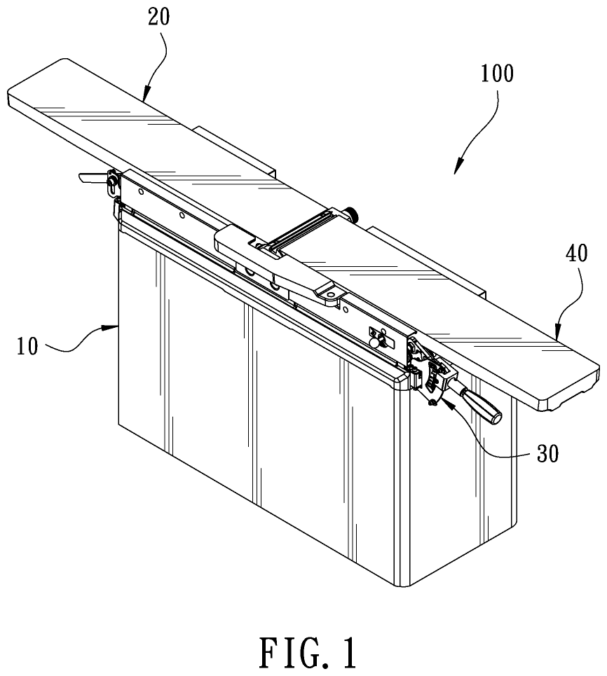

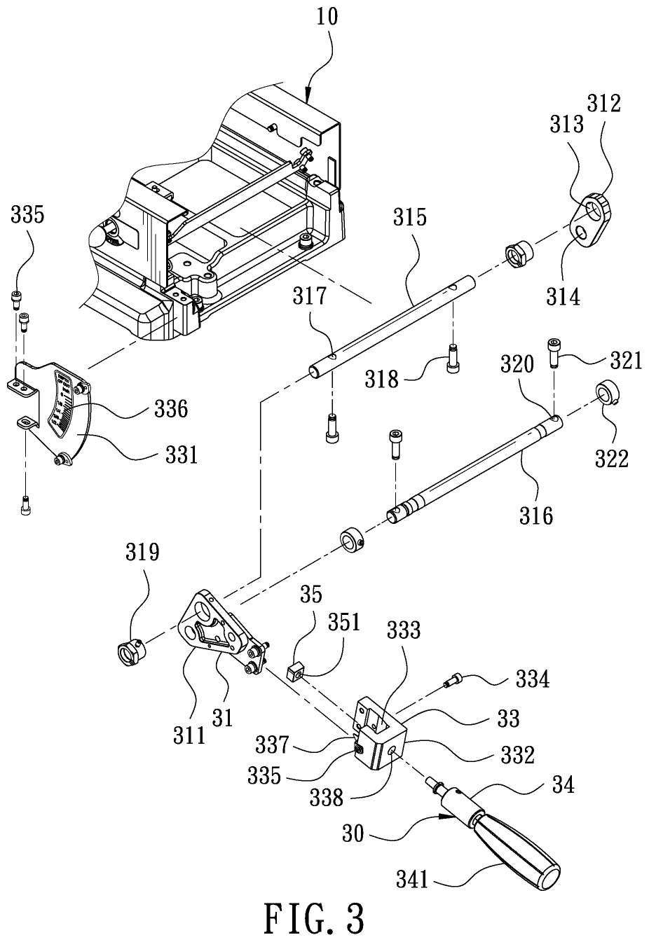

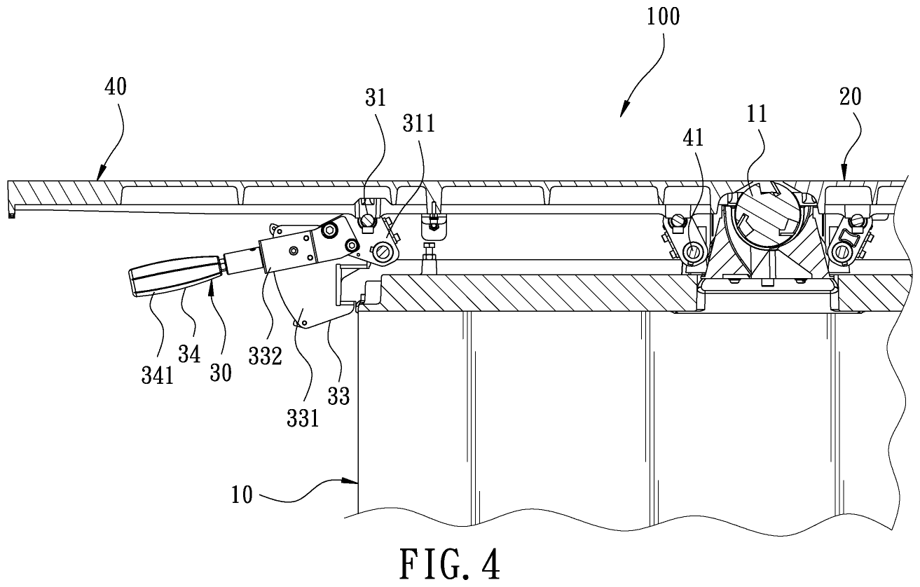

A preferred embodiment of a hand-operated planer provided with both a fixed workbench and a lifting mechanism with a locking function in the present invention, as shown in FIGS. 1-4, includes a base 10, a fixed workbench 20, and a lifting mechanism 30 as main components combined together.

The base 10 is provided with a cutting member 11, which is located at a top intermediate portion of the base 10.

The fixed workbench 20 is secured at a first side of the base 10.

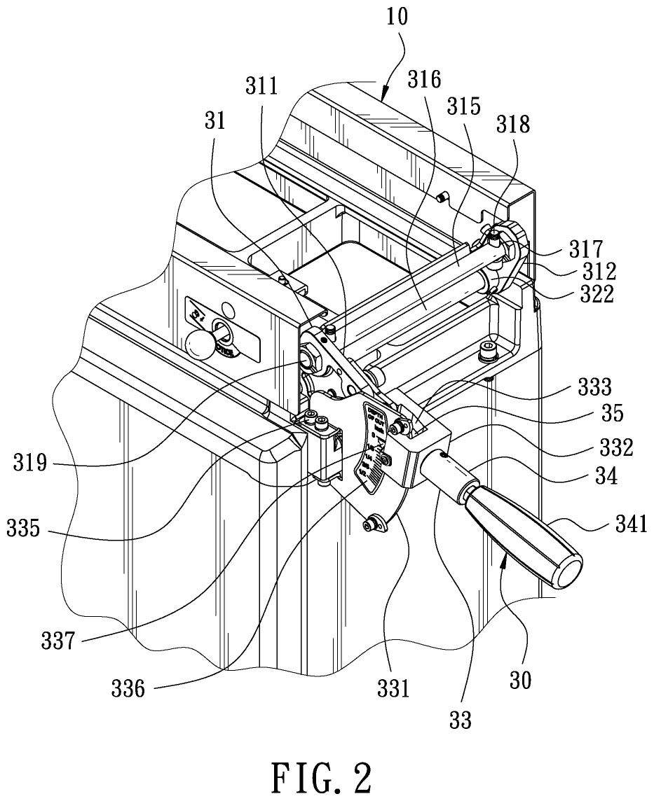

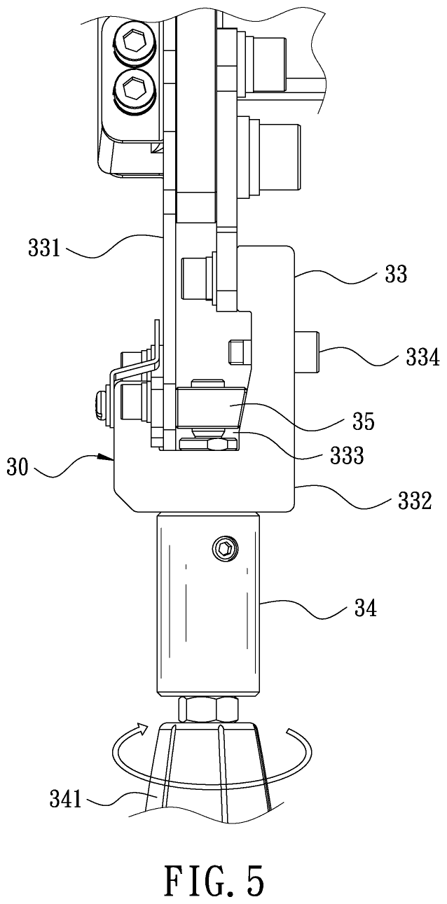

The lifting mechanism 30, referring to FIGS. 1 and 2, includes a connecting seat 31, a position-limiting member 33, an operating rod 34 and a positioning block 35. The connecting seat 31 has two sides respectively provided with a driving plate 311 and a driven plate 312, and the driving plate 311 and the driven plate 312 are respectively and correspondingly bored with a combination hole 313 and a through hole 314 respectively for a connecting rod 315 and a shaft rod 316 to be inserted therein. The connecting rod 315 is approximately cylinder-shaped and has two ends are respectively provided with an insert hole 317 at a predetermined position for an insert pin 318 to be inserted therein for stably fixing the connecting rod 315 at the movable workbench 40. Further, the connecting rod 315 has two ends respectively and pivotally connected with the combining hole 313 of the driving plate 311 and the through hole 314 of the driven plate 312 by means of a nut 319. Furthermore, the shaft rod 316 has two ends respectively bored with a through hole 320 at a predetermined location for receiving a fastener 321 therein so that the shaft rod 316 can be stably fixed on the base 10, and the shaft rod 316 has two ends respectively screwed in the combining hole 313 and the through hole 314 by means of a screw element 322, the connecting rod 315 and the shaft rod 316 being parallel to each other. The position-limiting member 33 consists of a position-limiting plate 331, a position-limiting block 332, a position-limiting groove 333 and a stopper 334. The position-limiting plate 331 has one end provided with a plurality of screws 335 by which the position-limiting plate 331 can be firmly connected with the base 10, and the position-limiting plate 331 is further provided with a graduated scale 336 and partly connected with the position-limiting block 332. The position-limiting block 332 is connected with the driving plate 311 of the connecting seat 31 and formed with a position-limiting groove 333, which is a wedge groove, as shown in FIG. 5. The position-limiting block 332 is fixedly connected with the stopper 334 at the location of the opening, and scale block 332 is provided with a scale indicator 337, which has one end connected with the position-limiting block 332 via a screw 335. The position-limiting block 332 is bored with a penetrating hole 338 for the operating rod 34 to be inserted therein, and the operating rod 34 has its free end is mounted with a positioning block 35 corresponding to the position-limiting groove 333. The positioning block 35 has two sides respectively pressing against the position-limiting plate 331 and the position-limiting block 332. The positioning block 35 is formed with a threaded hole 351, and the operating rod 34 has one end screwed with the threaded hole 351 of the positioning block 35 and another end locked with a handle 341.

The movable workbench 40 is provided at a second side of the base 10, having one underside connected with the connecting seat 31 and another underside connected with a coupled seat 41, the coupled seat 41 and the connecting seat 31 are similar in structure and no need to give unnecessary details. The movable workbench 40 and the fixed workbench 20 are provided at the same level and jointly defined to have a plane surface. When the handle 341 of the operating rod 34 is operated, the operating rod 34 will actuate the position-limiting block 332 and the connecting seat 31 to act together to enable the driving plate 311 to actuate the driven plate 312 to rotate through transmission of the connecting rod 315 and meanwhile, the coupled seat 41 will be actuated to act and thus, the movable workbench 40 assembled above the axis of the connecting seat 31 can be adjusted in height.

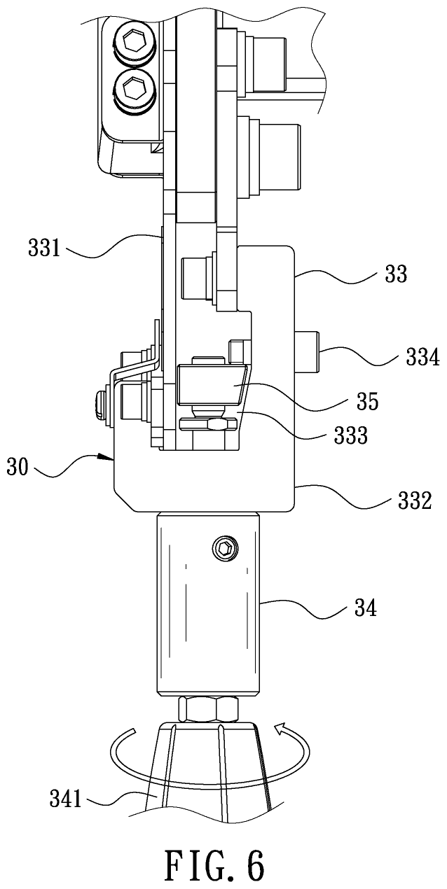

Referring to FIG. 6, to carry out fine adjustment, firstly, rotate the handle 341 according to first direction to make the operating rod 34 actuate the positioning block 35 to move to the opening of the position-limiting block 332, letting two sides of the positioning block 35 disengaged from both the position-limiting plate 331 and the side wall of the position-limiting groove 333, letting the positioning block 35 released in the position-limiting groove 333. Thus, the operating rod 34 can be adjusted upward and downward and further, the stopper 334 can restrict the moving range of the positioning block 35 to prevent the positioning block 35 from exceeding the stopper 334 and falling off.

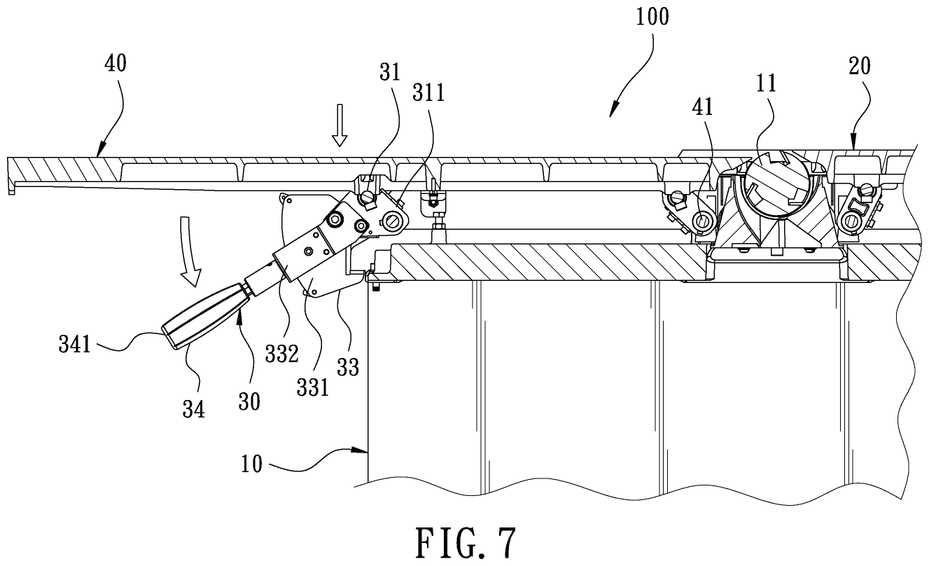

Referring to FIGS. 2 and 7, to adjust the height of the movable workbench 40, firstly, operate the handle 341 of the operating rod 34 to let the operating rod 34 actuate the position-limiting block 332 to act together with the connecting seat 31 and enable the driving plate 311 to make the driven plate 312 rotate through transmission of the connecting rod 315 and simultaneously, the rotation of the driven plate 312 will drive the coupled seat 41 to move so that the movable workbench 40 assembled above the axis of the connecting seat 31 can be adjusted in height. By so designing, the movable workbench 40 of the hand-operated planer 100 can be adjusted in height with one stage adjustment and with one single hand operation, convenient in use.

Referring to FIG. 5, when finishing adjustment, the handle 341 of the operating rod 34 needs to be rotated along another direction to let the operating rod 34 operated together with the positioning block 35 to have the positioning block 35 moved in the position-limiting groove 333, letting two sides of the positioning block 35 press against both the position-limiting plate 331 and the side wall of the position-limiting groove 333. Since the position-limiting groove 333 is a wedge-shaped groove able to restrict moving range of the positioning block 35, letting the positioning block 35 fixed in the position-limiting groove 333 and the operating rod 34 impossible to be operated, thus attaining locking effect.

Referring to FIG. 2, what is worthy of mentioning is that the position-limiting block 332 is provided with the scale indicator 337, which can follow the lifting situation of the movable workbench 40 relative to the base 10 and show a lifting value on the graduated scale 336 so that a user can know the lifting range of the movable workbench 40, convenient in use.

While the preferred embodiment of the invention has been described above, it will be recognized and understood that various modifications may be made therein and the appended claims are intended to cover all such modifications that may fall within the spirit and scope of the invention.

What is claimed is:

1. A hand-operated planer provided with both a fixed workbench and a lifting mechanism with a locking function, said hand-operated planer comprising a base, said base provided with a cutting member, said base having two sides respectively provided with a fixed workbench and a movable workbench, said lifting mechanism comprising:
a connecting seat rotatably connected with said base and said movable workbench, said connecting seat connected with a position-limiting member, said position-limiting member comprising a position-limiting groove, said position-limiting member inserted with an operating rod, said operating rod having a free end fixed with a positioning block corresponding to said position-limiting groove; and
said operating rod able to actuate said positioning block to be fixed or to be released in said position-limiting groove, said operating rod able to actuate said position-limiting member together with said connecting seat to act and adjust the height of said movable workbench when said positioning block is released in the position-limiting groove, said operating rod tightly locked in said position-limiting groove when said positioning block is engaged and fixed in said position-limiting groove.

2. The hand-operated planer provided with both a fixed workbench and a lifting mechanism with a locking function as claimed in claim 1, wherein said position-limiting member is provided with a penetrating hole for said operating rod to be inserted therein.

3. The hand-operated planer provided with both a fixed workbench and a lifting mechanism with a locking function as claimed in claim 1, wherein said positioning block is formed with a threaded hole, said operating rod having one end threadably fixed with said threaded hole of said positioning block and another end fixedly locked with a handle.

4. The hand-operated planer provided with both a fixed workbench and a lifting mechanism with a locking function as claimed in claim 1, wherein said position-limiting groove is a wedge-shaped groove.

5. The hand-operated planer provided with both a fixed workbench and a lifting mechanism with a locking function as claimed in claim 1, wherein said position-limiting member comprises a position-limiting plate and a position-limiting block, said position-limiting plate having one end connected with said base, said position-limiting block provided with said position-limiting groove, said position-limiting plate having a part connected with said position-limiting block.

6. The hand-operated planer provided with both a fixed workbench and a lifting mechanism with a locking function as claimed in claim 1, wherein said position-limiting block has one side fixedly connected with a stopper, said stopper fixedly connected with a location of an opening of said position-limiting block.

7. The hand-operated planer provided with both a fixed workbench and a lifting mechanism with a locking function as claimed in claim 1, wherein said position-limiting plate provided a graduated scale, said graduated scale pivotally connected with a scale indicator, said scale indicator having one end connected with said position-limiting block.

8. The hand-operated planer provided with both a fixed workbench and a lifting mechanism with a locking function as claimed in claim 1, wherein two sides of said positioning block can respectively press against said position-limiting plate and said position-limiting block.
